(19) United States
(12) Patent Application Publication
(10) Pub. No.: US 2025/0229447 A1
(43) Pub. Date: Jul. 17, 2025

(54) FOOD PRODUCT SLICER AND ASSOCIATED CARRIAGE TRACKING SYSTEM

(71) Applicant: ILLINOIS TOOL WORKS INC., Glenview, IL (US)

(72) Inventors: Matthew W. BIRD, Xenia, OH (US); Lawrence S. LEUNG, Troy, OH (US)

(21) Appl. No.: 18/950,679

(22) Filed: Nov. 18, 2024

Related U.S. Application Data
(60) Provisional application No. 63/620,550, filed on Jan. 12, 2024.

(51) Int. Cl. B26D 7/06; B26D 1/143; B26D 5/00

(52) U.S. Cl. CPC B26D 7/0616; B26D 5/00; B26D 1/143; B26D 2210/02

(57) ABSTRACT

A food product slicer includes a base, a knife mounted for rotation relative to the base, a carriage mounted to the base for reciprocal movement back and forth past a cutting edge of the knife and a drive linked to move the carriage. A distance sensing system is arranged to detect a distance of a movable part from a defined location, wherein the movable part is part of the drive or part of the carriage, in order to detect and track a position of the carriage.

### TECHNICAL FIELD

This application relates generally to food product slicers of the type commonly used to slice bulk food products and, more specifically, to a carriage tracking system in such a food product slicer.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. An auto drive system for the carriage includes a drive motor that is typically linked via a belt, and a transport connected to the belt, to drive the carriage back and forth during an automatic slicing operation carried out by a controller of the slicer.

In the auto drive system of a slicer, there is generally the need for a feedback loop from a motor (such as a brushless DC motor) to the motor controller. Essentially the motor controller needs to be able to determine the motor position somewhat precisely. This is generally accomplished by an encoder attached to the motor. The encoder allows the relative position of the motor shaft to be determined with a high degree of accuracy while the motor controller is powered up.

With many existing slicers, once the machine powers down, the controller is not set up to monitor any motor movement. This creates an issue at slicer power up. If there is a specific profile that the motor controller will use to control the motor for carriage movement, the motor controller must know where the motor/transport is at (i.e., where the carriage is located). If, upon powering down, the transport/carriage was left at the front of the machine, but after powering down the transport/carriage was moved to the rear, the motor controller in this scenario will not recognize that the transport/carriage is now at the rear of the machine and, if not resolved, will send the transport/carriage into the rear wall. To avoid this occurrence there are several solutions that exist on slicers today: physical limit switches to signal to the controller that the transport is at the end of its stroke, or approaching the end of its stroke; proximity magnetic switches can be used to force an enable before starting the machine (in order to start the machine, you must first move the transport so that this switch is actuated-the motor controller would then know where the transport is at along the stroke); or the motor controller could automatically send the motor one direction very slowly until it lightly hits the end of the stroke. The end of the stroke can be determined by detecting motor current differences.

Sending the carriage down to the rear wall slowly takes additional time and is somewhat unintuitive to the operator. Forcing the operator to put the transport at a specific spot can also be somewhat unintuitive. The limit switch option is feasible but has some limits when it comes to faster speeds and accuracy of this method at a production level (without necessitating some on the line adjustment during assembly).

Accordingly, it would be desirable to provide a slicer with a system that is better able to recognize and track the position of the carriage.

### SUMMARY

In one aspect, a food product slicer includes a base, a knife mounted for rotation relative to the base, a carriage mounted to the base for reciprocal movement back and forth past a cutting edge of the knife and a drive linked to move the carriage. A distance sensing system is arranged to detect a distance of a movable part from a defined location, wherein the movable part is part of the drive or part of the carriage, in order to detect and track a position of the carriage.

In another aspect, a food product slicer includes a base, a knife mounted for rotation relative to the base, a carriage mounted to the base for reciprocal movement back and forth past a cutting edge of the knife, and a drive linked to move the carriage. A time-of-flight sensor is arranged to detect an actual distance of a movable part from a defined location, wherein a movement of the movable part directly corresponds to a movement of the carriage.

In another aspect, a food product slicer includes a base, a knife mounted for rotation relative to the base, a carriage mounted to the base for reciprocal movement back and forth past a cutting edge of the knife and a drive linked to move the carriage, the drive including a motor and an encoder associated with the motor. An energy harvesting arrangement is configured for providing power to the encoder when the food product slicer is unpowered.

### BRIEF DESCRIPTION OF DRAWINGS

FIGS. 1 and 2 show a food product slicer;

FIG. 3 shows the food product slicer with body removed to reveal internal parts;

FIGS. 4 and 5 show views of the belt dive assembly;

FIG. 6 shows a schematic of a distance sensing system of the slicer;

FIGS. 7-8 show an exemplary configuration and positioning of a time-of-flight sensor.

### DETAILED DESCRIPTION

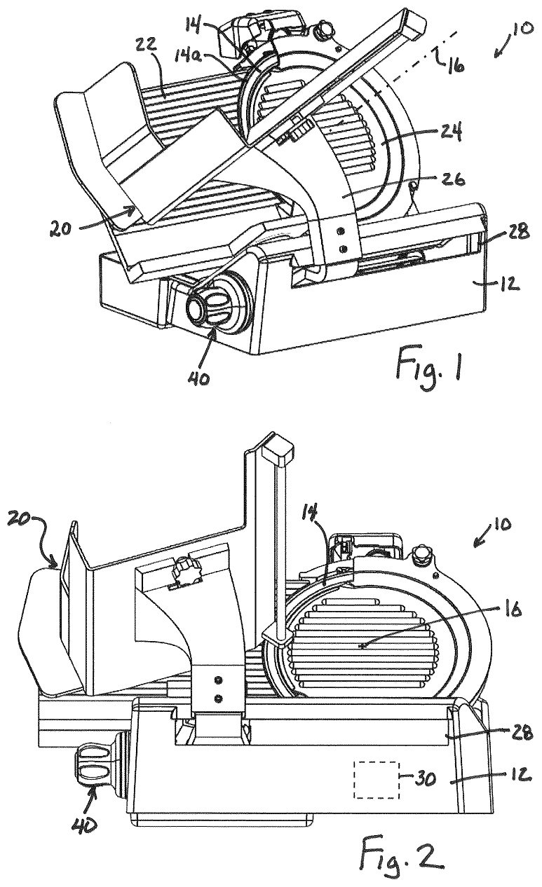

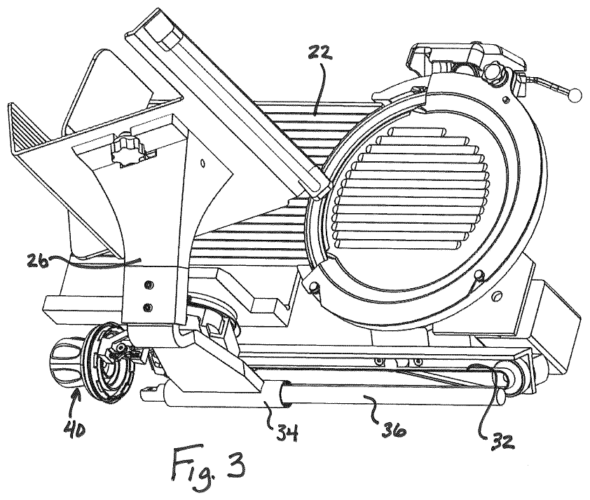

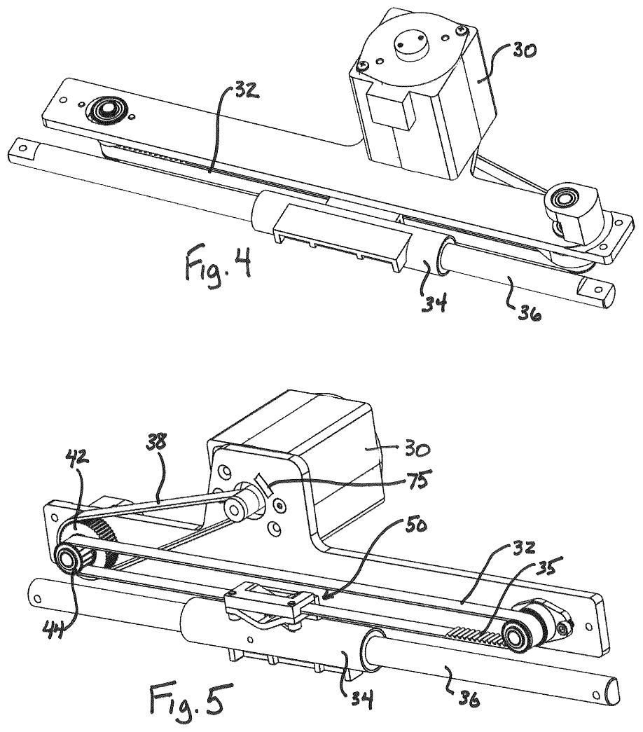

Referring to FIGS. 1-5, a food product slicer 10 includes a housing or base 12 and a circular, motor-driven slicing knife 14 that is mounted to the housing for rotation about an axis 16. FIG. 2 depicts a right-side view of the slicer. The left side of FIG. 2, where the controls are located, is generally referred to as the front side of the slicer (which is where an operator stands for slicing), the right side of FIG. 2 is generally referred to as the rear side of the slicer. A food product can be supported on a motor driven food carriage 20 which moves the food product to be sliced past the cutting edge 14a of the rotating slicing knife 14. The food carriage 20 reciprocates from left to right relative to FIG. 2, along a linear path so that the lower end of the bulk food product slides along the surface of a gauge plate 22, is cut by the knife 14 and then slides along a knife cover plate 24. A gauge plate system includes a rotatable knob 40 that that is linked to adjust the position of the gauge plate for slice thickness control.

The food carriage 20 includes a tray mounted on a tray arm 26 that orients the food carriage tray at the appropriate angle (typically perpendicular) to the knife cutting-edge plane. The food carriage arm, or a part on which the arm is mounted, reciprocates in a slot 28 at a lower portion of the housing 12. The carriage 20 can be moved manually (e.g., by a handle) and/or the carriage 20 may also be automatically driven. Here, an internal motor 30 drives a belt 32 that is linked internally to a tubular transport part 34 that is connected the arm 26, and the tubular transport part 34 rides along a slide rod 36. In particular, the motor 30 moves an output belt 38 to rotate a gear 42, that in turn includes a drive pulley 44 that is engaged with the belt 32, and the belt 32 also extends about a spaced apart idler pulley 46. The transport part 34 is coupled to the belt 32 for movement with the belt by a belt connection 50, which here is a clamped connection onto the belt.

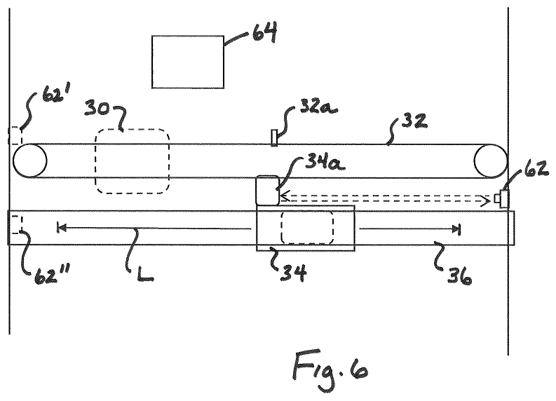

Referring to FIG. 6, a schematic depiction of a distance sensing system 60 of the slicer is shown, and includes a distance sensor 62 positioned to detect a location of a portion 34a of the transport 34 from a defined location, which is the location of the sensor 62 itself. In one implementation, sensor 62 is a Time-of-Flight (ToF) sensor. This sensor 62 can be used to track and update positioning with communication to slicer controller 64. This sensor 62 can also be used by the controller 64 to count and record carriage strokes. A ToF sensor is a range imaging system for measuring distances between the sensor and the detectable subject/part based on time-of-flight, which is the round trip time of an artificial light signal, as may provided by a laser or an LED or other light source acting as an emitter of the sensor, which light signal travels to the subject/part and is reflected back to the sensor for detection by a detector of the sensor. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group-including hardware or software that executes code), software, firmware and/or other components, or a combination of some or all of the above, that carries out the control functions of the machine or the control functions of any component thereof. The controller 64 may operate as part of both the distance sensing system 60 and part of the drive (e.g., where the controller 64 is configured to operate the motor 30).

In one embodiment, the ToF sensor 62 is able to detect and monitor the transport 34 throughout the entire transport stroke length L. In this embodiment, the requirement for homing is reduced, since the controller 64 will determine where the transport, and thus the carriage is at all times. However, in such an embodiment a homing process might still be implemented, and placement of the sensor 62 at the rear portion of the slicer toward the end of the slicing stroke, as per FIG. 6, may still be advantageous for providing the highest position resolution toward the end of the slicing stroke.

In another embodiment, the ToF sensor 62 cannot detect or “see” the transport 34 throughout the entire transport stroke length. In this design, the ToF sensor 62 is limited to a specific range and cannot resolve the transport position throughout the entire transport stroke length. The ToF sensor in such and embodiment will be short sighted and have a higher resolution/accuracy than if it could detect the entire stroke length. In such an embodiment, the ToF sensor 62 should be placed at the rear portion of the slicer, such that the ToF sensor would only be able to see the transport when the carriage is located beyond the slicer knife, after the machine has cut a slice (at the cut or rear end of machine as opposed to the home or front end of machine). In this embodiment, the controller 64 can still use the sensor output to count strokes. However, a “homing process” may also be implemented because the sensor cannot resolve the transport position throughout the entire transport stroke length.

In implementations, to “home” the transport position, the following process is carried out by the controller:
(1) Check if the ToF sensor can see transport.
(2) If “yes”, then measure the distance to the transport and use that data to “home” and update the actual transport position (within the motor controller).
(3) If “no”, then start the motor at the predefined stroke profile normally used for slicing (this differs from standard “homing processes” which will send the transport down very slowly). Since the ToF max range is known, the location of the transport is known to be within a range (if ToF sensor can only see 10 cm, and the ToF sensor is reading “max range” or “10 cm”, the controller is configured to initially assume that the transport is anywhere from 10 cm to the opposite end of the stroke). As soon as the motor starts the normal slicing stroke, it will assume that the transport started at the front end of the stroke (even though the transport is actually somewhere between 10 cm and the front end of the stroke). At a predetermined time interval, the controller checks to see if the ToF sensor has started sensing the transport. As soon as the ToF sensor has started sensing or detecting the transport, the controller updates the actual transport position. In implementations, the update is continuous and not just instantaneous. Continual updates all the way to the end of the stroke will ensure a high degree of accuracy.

This design utilizes the ToF sensor to “catch” the transport or carriage and determine its location with a dynamic homing process (aka dynamic zeroing), which homing process does not require the transport or carriage to reach either end of its full stroke in order to determine the actual position.

In another embodiment, the ToF sensor 62 (if it monitors the transport throughout its entire stroke length), could be used to replace the relative encoder on the motor. If the ToF sensor 62 can resolve the actual transport position with enough accuracy, a feedback loop of relative motor rotation back to the controller is not needed.

Advantages of the above system include one or more of (i) elimination of additional sensors to count strokes, (ii) potential to eliminate reduntant components (motor rotary encoder), and (iii) operator intuition increases as the machine will not need the transport/carriage to be at the home position at the front of the machine before allowing the machine to start, or will not need to run a homing process before beginning the slice stroke profile.

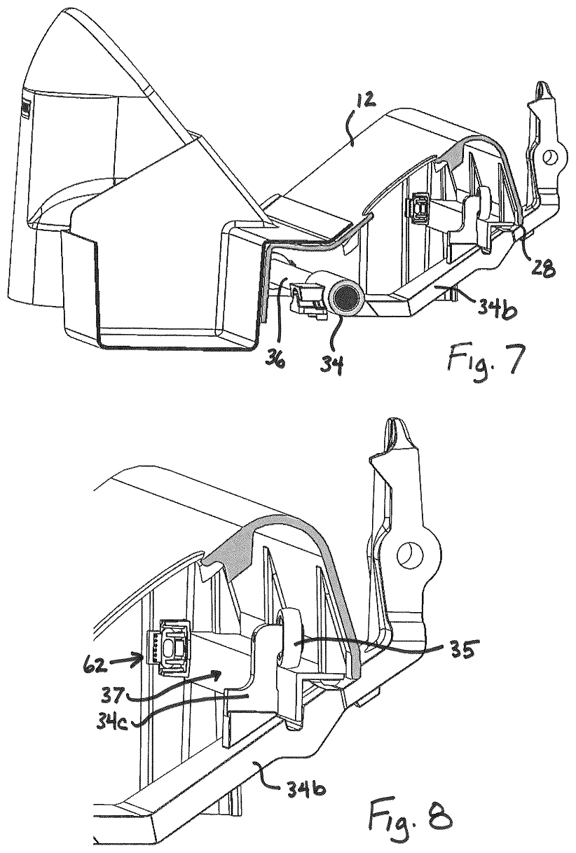

Referring to FIGS. 7-8, in one implementation, the transport 34 includes an integral support 34b that extends through the slot 28 and onto which the arm of the food carriage mounts. The support 34b includes a bracket 34c to which a support roller 35 is mounted, and the roller 35 rides along the upper surface of a rail 37. The sensor 62 is mounted at the rear end of the rail 37 and is oriented for detecting the position of the bracket 34c.

In an alternative solution, a distance sensor is not used. In this solution the controller 64 monitors position only with a relative encoder/sensor, but includes a system to monitor the encoder/sensor even when the machine is powered off. This would allow for the controller 64 to keep an updated position of the transport, and thus the carriage, even if the machine is not supplied with power. So, in the instance that the machine is powered down, the transport is moved, and the powered back on, the machine would have an updated and accurate transport position measurement in memory. To temporarily power the encoder/sensor and move this data to storage, energy can be harvested from the unpowered machine. This energy harvesting is made feasible, for example, by utilizing electromagnetic induction or the Wiegand effect. Manual movement of the carriage in turn causes rotation of the motor 30, creating an electromagnetic field from which energy can be harvested by use of a Wiegand sensor 75 (FIG. 5).

It is to be clearly understood that the above description is intended by way of illustration and example only and is not intended to be taken by way of limitation. Variations are possible. For example, while the system in FIG. 6 detects a distance to a portion 34a of the transport 34, the sensor could detect other movable parts. In particular, the detected movable part could be any of (i) a part 32a of the belt 32, per sensor position 62′ (if position of the transport on the belt is known), a part 34a of the transport 34 or part of the carriage arm or arm mount, per sensor position 62″ (preferably a portion of the arm/arm mount within the housing of the slicer) or (ii) a component (e.g., a component designed to enhance reflection) that is connected to part of the belt, part of the transport or part of the arm. The movement of any one of these options corresponds directly to a movement of the carriage (e.g., 1 mm of linear movement of the monitored part corresponds to 1 mm of movement of the carriage). Other variations are possible.

1. A food product slicer, comprising:
a base;
a knife mounted for rotation relative to the base;
a carriage mounted to the base for reciprocal movement back and forth past a cutting edge of the knife;
a drive linked to move the carriage;
a distance sensing system arranged to detect an actual distance of a movable part from a defined location, wherein the movable part is part of the drive or part of the carriage.

2. The food product slicer of claim 1, wherein the distance sensing system includes a sensor and a controller configured to detect and track a position of the carriage and control operation of a motor of the drive.

3. The food product slicer of claim 1, wherein the distance sensing system comprises a time-of-flight sensor with an emitter oriented to emit a light signal toward the movable part, and having a detector to detect reflection of the light signal from the movable part back to the time of flight sensor.

4. The food product slicer of claim 3, wherein the drive includes a movable belt and a transport linked for movement with the belt, wherein the carriage includes an arm connected to the transport for movement with the transport, wherein the movable part is (i) part of the belt, part of the transport or part of the arm or (ii) a component connected to part of the belt, part of the transport or part of the arm.

5. The food product slicer of claim 3, wherein the drive includes a motor and associated controller for controlling the motor, and the time-of-flight sensor provides time of flight information or distance information to the controller.

6. The food product slicer of claim 3, wherein the movable part has a stroke length corresponding to a stroke length of the carriage, and the time-of-flight sensor is configured for detecting the distance of the movable part from the defined location at all locations of the movable part along the stroke length.

7. The food product slicer of claim 3, wherein the movable part has a stroke length corresponding to a stroke length of the carriage, and the time-of-flight sensor is configured for detecting the distance of the movable part from the defined location only when the movable part is within a set range of the defined location, wherein the set range is smaller than the stroke length.

8. The food product slicer of claim 7, wherein the defined location is at or near an end of the stroke length at which the carriage is located beyond the knife toward a rear of the slicer, wherein the set range is defined by a rear portion of the stroke length.

9. The food product slicer of claim 1, wherein the defined location is at or near an end of the stroke length at which the carriage is located beyond the knife toward a rear of the slicer.

10. A food product slicer, comprising:
a base;
a knife mounted for rotation relative to the base;
a carriage mounted to the base for reciprocal movement back and forth past a cutting edge of the knife;
a drive linked to move the carriage;
a time-of-flight sensor arranged to detect an actual distance of a movable part from a defined location, wherein a movement of the movable part directly corresponds to a movement of the carriage.

11. The food product slicer of claim 10, further comprising a controller configured to receive distance information or time-of-flight information from the time-of-flight sensor, the controller configured detect and track a position of the carriage and control operation of a motor of the drive.

12. The food product slicer of claim 11, wherein, upon power up of the food product slicer, the controller is configured to carry out a dynamic homing process to determine an actual position of the movable part before the carriage reaches either end of its full stroke length.

13. The food product slicer of claim 10, wherein the time-of-flight sensor is mounted internally of the base toward a rear end of the slicer.

14. The food product slicer of claim 13, wherein the time-of-flight sensor is mounted on or near a rail, wherein the drive includes a movable belt and a transport linked for movement with the belt, wherein the transport includes a support extending therefrom and comprising a roller that rides on the rail, and the movable part is the support or a component mounted to the support.

15. A food product slicer, comprising:
a base;
a knife mounted for rotation relative to the base;
a carriage mounted to the base for reciprocal movement back and forth past a cutting edge of the knife;
a drive linked to move the carriage, the drive including a motor and an encoder associated with the motor;
an energy harvesting arrangement for providing power to the encoder when the food product slicer is unpowered.
